(19) United States
(12) Patent Application Publication
(10) Pub. No.: US 2022/0321930 A1
(43) Pub. Date: Oct. 6, 2022

(54) CONTENT INSERTION INTO A CONTENT STREAM

(71) Applicant: ARRIS Enterprises LLC, Suwanee, GA (US)

(72) Inventor: Krishna Prasad PANJE, Bengaluru (IN)

(73) Assignee: ARRIS Enterprises LLC, Suwanee, GA (US)

(21) Appl. No.: 17/708,717

(22) Filed: Mar. 30, 2022

Related U.S. Application Data
(60) Provisional application No. 63/168,480, filed on Mar. 31, 2021.

(51) Int. Cl. H04N 21/2368; H04N 21/8547; H04N 21/2662

(52) U.S. Cl. CPC H04N 21/2368; H04N 21/8547; H04N 21/2662

(57) ABSTRACT

A system for rendering additional content into a low-bandwidth content stream using only one or more I-frames.

### CROSS REFERENCE TO RELATED APPLICATIONS

This application claims the benefit of U.S. Provisional Patent Application Ser. No. 63/168,480 filed Mar. 31, 2021.

### BACKGROUND

The subject matter of this application relates to content insertion into a content stream.

Cable system operators and other network operators provide streaming media to a gateway device for distribution in a consumer's home. The gateway device offers a singular point to access different types of content, such as live content, on-demand content, online content, over-the-top content, and content stored on a local or a network based digital video recorder. The gateway enables a connection to home network devices. The connection may include, for example, connection to a WiFi router or a Multimedia over Coax Alliance (MoCA) connection that provide IP over in-home coaxial cabling.

Consumers prefer to use devices that are compliant with standard protocols to access streaming video from the gateway device, so that all the devices within the home are capable of receiving streaming video content provided from the same gateway device. HTTP Live Streaming (HLS) is an adaptive streaming communications protocol created by Apple to communicate with iOS, Apple TV devices, and Macs running OSX Snow Leopard or later. HLS is capable of distributing both live and on-demand files, and is the sole technology available for adaptively streaming to Apple devices.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an overview of a cable system.

FIG. 2 illustrates HLS streaming video content.

FIG. 3 illustrates a HLS mater playlist.

FIG. 4 illustrates a HLS VOD playlist.

FIG. 5 illustrates an event playlist.

FIG. 6 illustrates an updated event playlist.

FIG. 7 illustrates a sliding window playlist.

FIG. 8 illustrates an updated sliding window playlist.

FIG. 9 illustrates a further updated sliding window playlist.

FIG. 10 illustrates various stream of content.

FIG. 11 illustrates various content profiles.

FIG. 12 illustrates a technique for inserting additional audio-visual content.

FIG. 13 illustrates an exemplary manifest for inserting additional audio-visual content.

### DETAILED DESCRIPTION

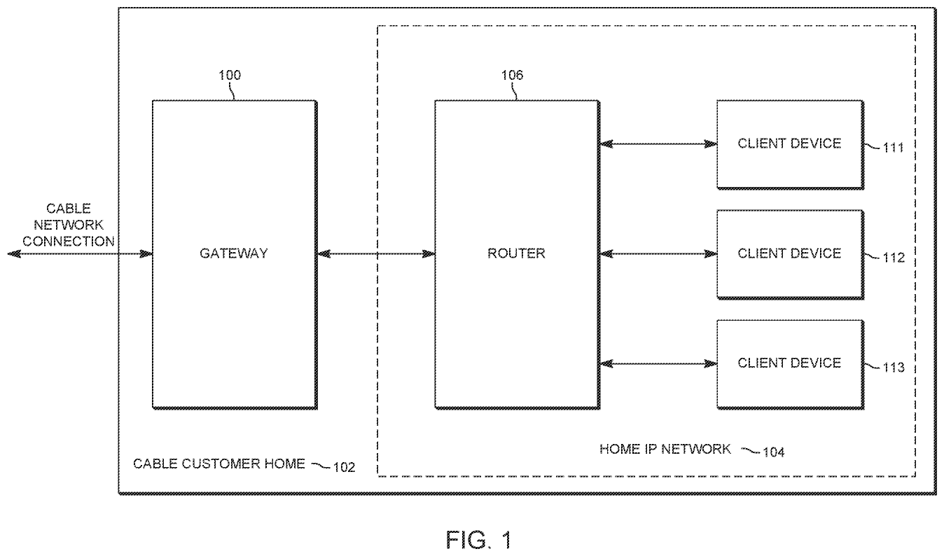

Referring to FIG. 1, a cable system overview is illustrated with a cable network connection provided to a gateway 100 of a cable customer's home 102. The cable network connection provided to the gateway 100 may be from a cable system operator or other streaming content provider, such as a satellite system. The gateway 100 provides content to devices in a home network 104 in the consumer's home 102. The home network 104 may include a router 106 that receives IP content from the gateway 100 and distributes the content over a WiFi or a cable connection to client devices 111, 112, 113. The router 106 may be included as part of the gateway 100. In general, the cable network connection, or other types of Internet or network connection, provides streaming media content to client devices in any suitable manner. The streaming media content may be in the form of HTTP Live Streaming (HLS), Dynamic Adaptive Streaming over HTTP (DASH), or otherwise.

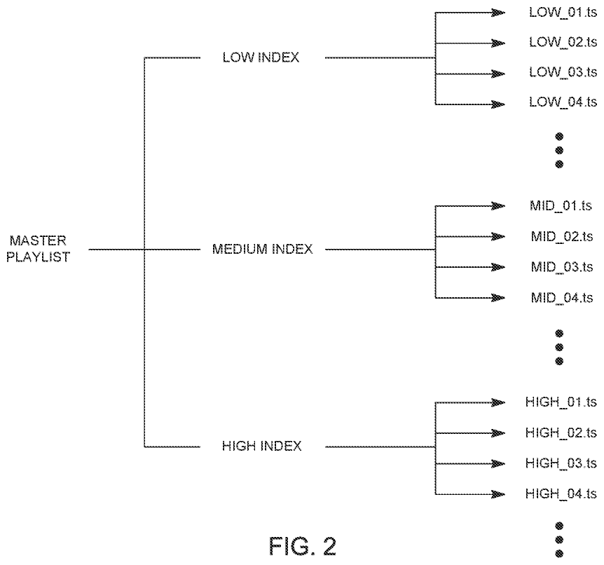

Referring to FIG. 2, at a high level HLS enables adaptive streaming of video content, by creating multiple files for distribution to a media player, which adaptively changes media streams being obtained to optimize the playback experience. HLS is a HTTP-based technology so that no streaming server is required, so all the switching logic resides on the player. To distribute content to HLS players, the video content is encoded into multiple files at different data rates and divided into short chucks, each of which is typically between 5-10 seconds long. The chunks are loaded onto a HTTP server along with a text based manifest file with a .M3U8 extension that directs the player to additional manifest files for each of the encoded media streams. The short video content media files are generally referred to as “chunked” files.

The player monitors changing bandwidth conditions over time to the player. If the change in bandwidth conditions indicates that the stream should be changed to a different bit rate, the player checks the master manifest file for the location of additional streams having different bit rates. Using a stream specific manifest file for a selected different stream, the URL of the next chuck of video data is requested. In general, the switching between video streams by the player is seamless to the viewer.

A master playlist (e.g., manifest file) describes all of the available variants for the content. Each variant is a version of the stream at a particular bit rate and is contained in a separate variant playlist (e.g., manifest file). The client switches to the most appropriate variant based on the measured network bit rate to the player. The master playlist isn't typically re-read. Once the player has read the master playlist, it assumes the set of variants isn't changing. The stream ends as soon as the client sees the EXT-X-ENDLIST tag on one of the individual variant playlists.

For example, the master playlist may include a set of three variant playlists. A low index playlist, having a relatively low bit rate, may reference a set of respective chunk files. A medium index playlist, having a medium bit rate, may reference a set of respective chunk files. A high index playlist, having a relatively high bit rate, may reference a set of respective chunk files.

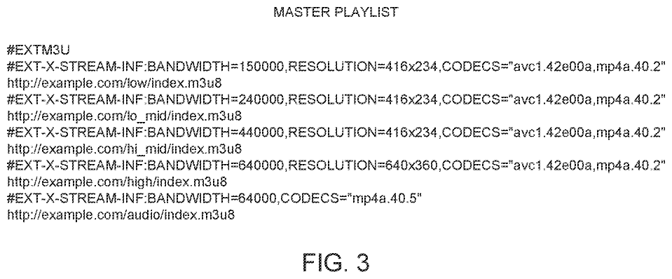

Referring to FIG. 3, an exemplary master playlist that defines five different variants is illustrated. Exemplary tags used in the master playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-STREAM-INF: Indicates that the next URL in the playlist file identifies another playlist file. The EXT-X-STREAM-INF tag has the following parameters.

AVERAGE-BANDWIDTH: An integer that represents the average bit rate for the variant stream.

BANDWIDTH: An integer that is the upper bound of the overall bitrate for each media file, in bits per second. The upper bound value is calculated to include any container overhead that appears or will appear in the playlist.

FRAME-RATE: A floating-point value that describes the maximum frame rate in a variant stream.

HDCP-LEVEL: Indicates the type of encryption used. Valid values are TYPE-0 and NONE. Use TYPE-0 if the stream may not play unless the output is protected by HDCP.

RESOLUTION: The optional display size, in pixels, at which to display all of the video in the playlist. This parameter should be included for any stream that includes video.

VIDEO-RANGE: A string with valid values of SDR or PQ. If transfer characteristic codes 1, 16, or 18 aren't specified, then this parameter must be omitted.

CODECS: (Optional, but recommended) A quoted string containing a comma-separated list of formats, where each format specifies a media sample type that's present in a media segment in the playlist file. Valid format identifiers are those in the ISO file format name space defined by RFC 6381 [RFC6381].

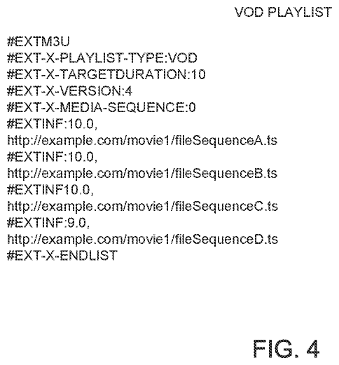

Referring to FIG. 4, one of the types of video playlists include a video on demand (VOD) playlist. For VOD sessions, media files are available representing the entire duration of the presentation. The index file is static and contains a complete list of URLs to all media files created since the beginning of the presentation. This kind of session allows the client full access to the entire program.

Exemplary tags used in the VOD playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-PLAYLIST-TYPE: Provides mutability information that applies to the entire playlist file. This tag may contain a value of either EVENT or VOD. If the tag is present and has a value of EVENT, the server must not change or delete any part of the playlist file (although it may append lines to it). If the tag is present and has a value of VOD, the playlist file must not change.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration.

EXT-X-ENDLIST: Indicates that no more media files will be added to the playlist file.

The VOD playlist example in FIG. 4 uses full pathnames for the media file playlist entries. While this is allowed, using relative pathnames is preferable. Relative pathnames are more portable than absolute pathnames and are relative to the URL of the playlist file. Using full pathnames for the individual playlist entries often results in more text than using relative pathnames.

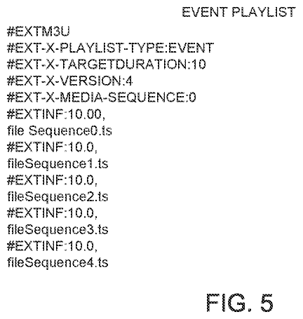

Referring to FIG. 5, an event playlist is specified by the EXT-X-PLAYLIST-TYPE tag with a value of EVENT. It doesn't initially have an EXT-X-ENDLIST tag, indicating that new media files will be added to the playlist as they become available.

Exemplary tags used in the EVENT playlist may include one or more of the following.

EXTM3U: Indicates that the playlist is an extended M3U file. This type of file is distinguished from a basic M3U file by changing the tag on the first line to EXTM3U. All HLS playlists start with this tag.

EXT-X-PLAYLIST-TYPE: Provides mutability information that applies to the entire playlist file. This tag may contain a value of either EVENT or VOD. If the tag is present and has a value of EVENT, the server must not change or delete any part of the playlist file (although it may append lines to it). If the tag is present and has a value of VOD, the playlist file must not change.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration.

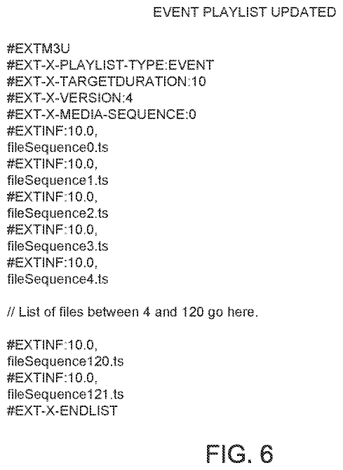

Items are not removed from the playlist when using the EVENT tag; rather new segments are appended to the end of the file. New segments are added to the end of the file until the event has concluded, at which time the EXT-X-ENDLIST tag may be appended. Referring to FIG. 6, the same playlist is shown after it's been updated with new media URIs and the event has ended. Event playlists are typically used when you want to allow the user to seek to any point in the event, such as for a concert or sports event.

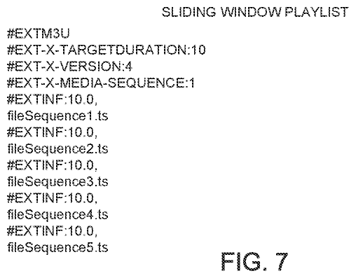

Referring to FIG. 7, a live playlist (sliding window) is an index file that is updated by removing media URIs from the file as new media files are created and made available. The EXT-X-ENDLIST tag isn't present in the live playlist, indicating that new media files will be added to the index file as they become available.

Exemplary tags used in the live playlist may include one or more of the following.

EXTM3U: Indicates that the playlist is an extended M3U file. This type of file is distinguished from a basic M3U file by changing the tag on the first line to EXTM3U. All HLS playlists must start with this tag.

EXT-X-TARGETDURATION: Specifies the maximum media-file duration.

EXT-X-VERSION: Indicates the compatibility version of the playlist file. The playlist media and its server must comply with all provisions of the most recent version of the IETF Internet-Draft of the HTTP Live Streaming specification that defines that protocol version.

EXT-X-MEDIA-SEQUENCE: Indicates the sequence number of the first URL that appears in a playlist file. Each media file URL in a playlist has a unique integer sequence number. The sequence number of a URL is higher by 1 than the sequence number of the URL that preceded it. The media sequence numbers have no relation to the names of the files.

EXTINF: A record marker that describes the media file identified by the URL that follows it. Each media file URL must be preceded by an EXTINF tag. This tag contains a duration attribute that's an integer or floating-point number in decimal positional notation that specifies the duration of the media segment in seconds. This value must be less than or equal to the target duration. In addition, the live playlist can use an EXT-X-ENDLIST tag to signal the end of the content. Also, the live playlist preferably does not include the EXT-X-PLAYLIST-TYPE type.

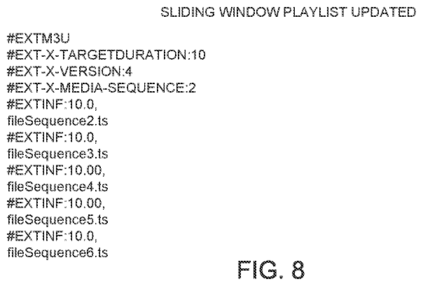

Referring to FIG. 8, the same playlist of FIG. 7 is shown after it has been updated with new media URIs.

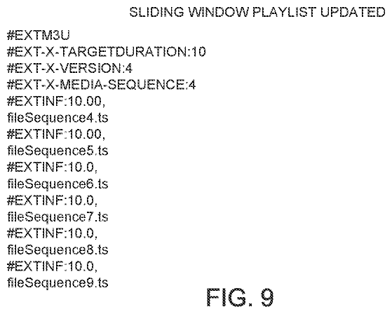

Referring to FIG. 9, the playlist FIG. 8 continues to be updated as new media URIs are added.

Another adaptive streaming technology is referred to as Dynamic Adaptive Streaming over HTTP (DASH), also generally referred to as MEGP-DASH, that enables streaming of media content over the Internet delivered from conventional HTTP web servers. MPEG-DASH employs content broken into a sequence of small HTTP-based file segments, where each segment contains a short interval of playback time of content. The content is made available at a variety of different bit rates. While the content is being played back at an MPEG-DASH enabled player, the player uses a bit rate adaptation technique to automatically select the segment with the highest bit rate that can be downloaded in time for playback without causing stalls or re-buffering events in the playback. In this manner, a MPEG-DASH enabled video player can adapt to changing network conditions and provide high quality playback with fewer stalls or re-buffering events. DASH is described in ISO/IEC 23009-1:2014 “Information technology—Dynamic adaptive streaming over HTTP (DASH)—Part 1: Media presentation description and segment formats”, incorporated by reference herein in its entirety.

In many video streaming technologies, including MPEG-2, the video frames are encoded as a series of frames to achieve data compression and typically provided using a transport stream. Each of the frames of the video are typically compressed using either a prediction based technique and a non-prediction based technique. An I frame is a frame that has been compressed in a manner that does not require other video frames to decode it. A P frame is a frame that has been compressed in a manner that uses data from a previous frame(s) to decode it. In general, a P frame is more highly compressed than an I frame. A B frame is a frame that has been compressed in a manner that uses data from both previous and forward frames to decode it. In general, a B frame is more highly compressed than a P frame. The video stream is therefore composed of a series of I, P, and B frames. MPEG-2 is described in ISO/IEC 13818-2:2013 “Information technology—Generic coding of moving pictures and associated audio information—Part 2: Video” incorporated by reference herein in its entirety. In some encoding technologies, including H.264, an IDR (instantaneous decoder refresh) frame is made up an intra code picture that also clears the reference picture buffer. However, for purposes of discussion the I frame and the IDR frame will be referred to interchangeably. In some encoding technologies, the granularity of the prediction types may be brought down to a slice level, which is a spatially distinct region of a frame that is encoded separately from any other regions in the same frame. The slices may be encoded as I-slices, P-slices, and B-slices in a manner akin to I frames, P-frames, and B-frames. However, for purposes of discussion I frame, P frame, and B frame are also intended to include I-slice, P-slice, and B-slice, respectively. In addition, the video may be encoded as a frame or a field, where the frame is a complete image and a field is a set of odd numbered or even numbered scan lines composing a partial image. However, for purposes of discussion both “frames” and “pictures” and “fields” are referred to herein as “frames”. H.264 is described in ITU-T (2019) “SERIES H: AUDIOVISUAL AND MULTIMEDIA SYSTEMS Infrastructure of audiovisual services—Coding of moving video”, incorporated by reference herein in its entirety.

As previously described, the server or otherwise a file storage location, maintains different playlists each of which normally having different bit rates (e.g., quality) indicating different files. The player downloads the playlist files, and then based upon available network bandwidth, or other criteria, selects files from an appropriate playlist. The player plays the files, each of which may be referred to as a chunk, if in sequential manner. The player monitors the available bandwidth, or other criteria, and selects additional files based upon the monitored criteria.

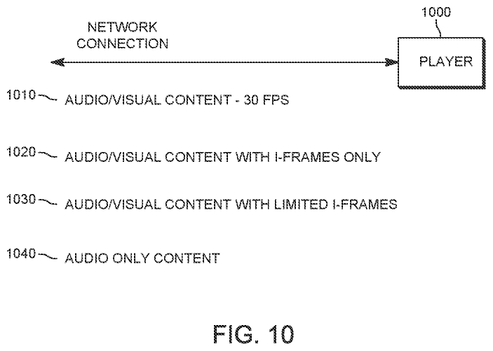

Referring to FIG. 10, the player 1000 may receive content in a variety of different formats, depending on the particular type of content desired. For example, the player may receive audio-visual content 1010 with audio content and video content that includes I frames, B frames, and P frames at a typical frame rate of 30 frames per second or greater. For example, the player may receive audio-visual content 1020 with audio content and video content that includes only I frames, typically as a lower frame rate than 30 frames per second. For example, the player may receive audio-visual content 1030 with audio content and video content that includes only I frames at a frame rate of an I frame occurring at intervals of 1 second or greater, and preferably 3 seconds or greater, and more preferably 5 seconds or greater. For example, the player may receive audio only content 1040. As it may be observed, the audio only content typically requires less bandwidth than audio-visual content with a limited number of I-frames, which typically requires a less bandwidth than typical audio-visual content.

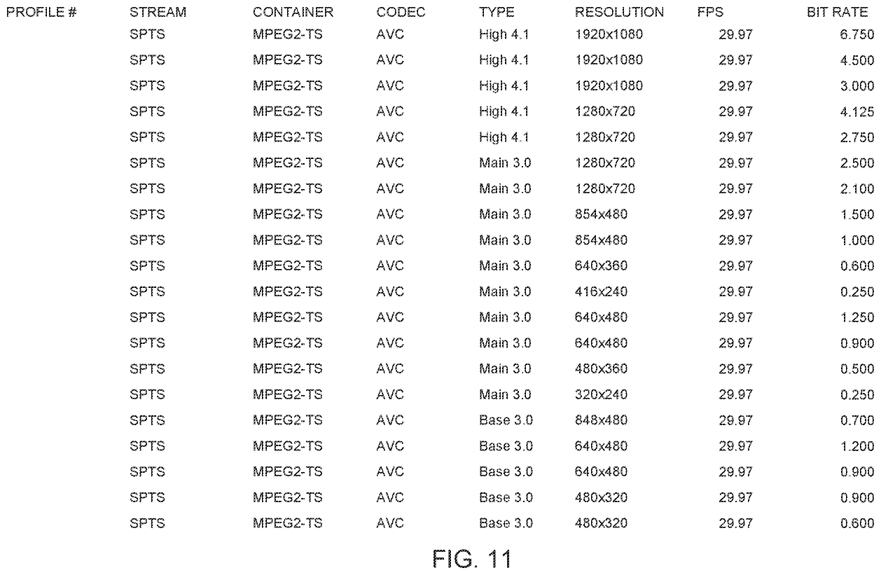

The player 1000 may receive its audio and/or audio-visual content in the form of a series of chunk files. Much of the audio and/or audio-visual content available is supported by audio-visual advertising which is desirable to be inserted into the series of chunk files. In addition, it is often desirable to insert other types of audio-visual content into the series of chunk files. The insertion of audio-visual content into other audio-visual content does not pose a problem, and may be performed by any suitable device, such as the gateway or a network based server (e.g., a cloud based server). However, when the player is receiving audio only content which has low bandwidth requirements, or audio-visual content containing only I frames with a limited frame rate (i.e., occurring at intervals of 1 second or greater, and preferably 3 seconds or greater, and more preferably 5 seconds or greater) that has low bandwidth requirements, there is only a limited amount of bandwidth required to provide the audio or audio-visual content to the player. When the audio-visual content insertion is included, especially in the case of an advertisement, the bandwidth requirements of the audio-visual content insertion is typically much higher than the other content being provided to the player. This change in the bandwidth requirements often results in a disruption in the experience of the user due to the substantial change in the bandwidth requirements, which may not be readily available. In addition, if a substantial number of audio-visual advertisements, each of which requires a substantial amount of bandwidth compared to a low-bandwidth stream, are inserted at the same time then the server side of the system may encounter bottlenecks. For example, the server may not have sufficient bandwidth to make available all of the requested files. For example, the server may not have sufficient computational resources to create the proper manifests and/or chunk files. Referring to FIG. 11, an exemplary set of content profiles are illustrated with the bit rates used for each.

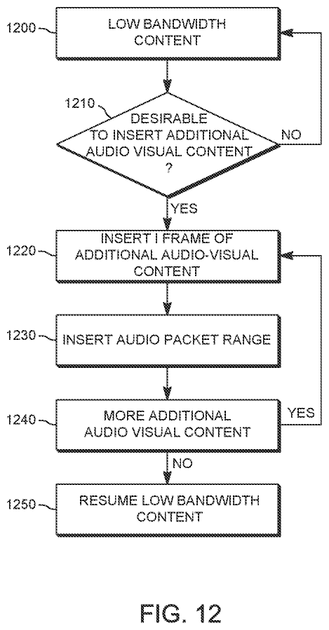

Referring to FIG. 12, a modified system may provide or otherwise make available low-bandwidth content 1200 (e.g., audio only content or audio-visual content containing only I frames with a limited frame rate (i.e., occurring at intervals of 1 second or greater, and preferably 3 seconds or greater, and more preferably 5 seconds or greater)). When it is desirable to insert additional audio-visual content 1210 that has greater bandwidth requirements, the system may process the manifest in a manner that reduces the bandwidth requirements for the insertion of the additional audio-visual content. The server may insert a first I frame of the additional audio-visual 1220 followed by a corresponding audio packet range 1230. For the duration of the additional-audio visual content 1210, the process of inserting an I frame 1220 and a corresponding audio packet range 1230 is repeated 1240. After completing of the insertion of the additional audio visual content 1210, the low bandwidth content is resumed 1250. The I frame may be marked by a discontinuity in the manifest, so that the content is treated as an I frame/audio only content. By way of example, the audio packet range may be between 5 and 10 seconds.

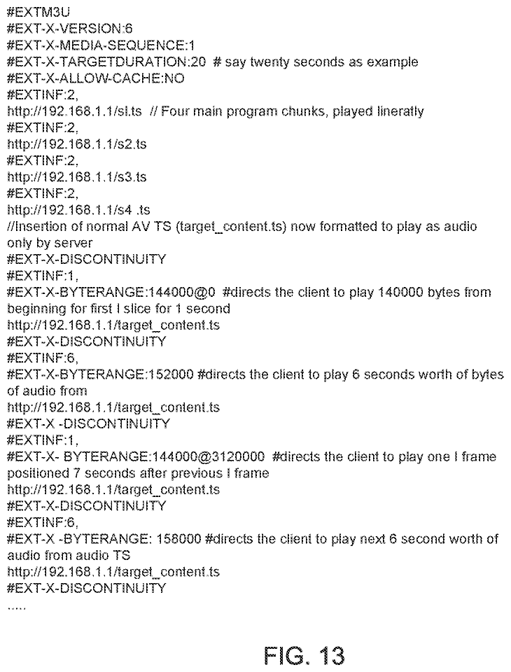

Referring to FIG. 13, an exemplary manifest that uses a discontinuity to insert the additional audio-visual content is illustrated. The discontinuity may be, for example, EXT-X-DISCONTINUITY: Indicates an encoding discontinuity between the media file that follows it and the one that preceded it.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

I/We claim:

1. A method for modifying a content stream comprising:
(a) a player receiving a first portion of said content stream that includes an audio stream together with either (i) not a corresponding video stream, or (ii) a corresponding video stream including only I frames at a frame rate of less than 1 frame per second;
(b) said player receiving an additional audio-visual content stream inserted into said content stream immediately after said first portion of said content stream that includes an audio stream together with a corresponding video stream including only I frames at a frame rate of less than 1 frame per second;
(c) said player receiving a second portion of said content stream immediately after said additional audio-visual content stream that includes an audio stream together with either (i) not a corresponding video stream, or (ii) a corresponding video stream including only I frames at a frame rate of less than 1 frame per second;
(d) wherein said corresponding video stream including only I frames at said frame rate of less than 1 frame per second for said additional audio-visual content stream is signaled based upon a discontinuity in a manifest file.

2. The method of claim 1 further comprising said player receiving said video stream over a cable network.

3. The method of claim 1 wherein said video stream is provided as a HTTP live streaming video stream.

4. The method of claim 1 wherein said video stream is provided as a dynamic adaptive streaming over HTTP video stream.

5. The method of claim 1 wherein said first portion of said content stream has not said corresponding video stream.

6. The method of claim 1 wherein said first portion of said content stream has said corresponding video stream including only I frames at a frame rate of less than 1 frame per second.

7. The method of claim 1 wherein said additional audio-visual content stream has a source file that includes a corresponding video stream having a frame rate of 30 frames per second or greater.

8. The method of claim 5 wherein said second portion of said content stream has not said corresponding video stream.

9. The method of claim 6 wherein said second portion of said content stream has said corresponding video stream including only I frames at a frame rate of less than 1 frame per second.

10. The method of claim 1 wherein said discontinuity is a discontinuity tag.

11. The method of claim 1 wherein said discontinuity is a discontinuity tag that indicates an encoding discontinuity between a file that follows it and the one that precedes it.
